(19) United States
(12) Patent Application Publication
(10) Pub. No.: US 2007/0194543 A1
(43) Pub. Date: Aug. 23, 2007

(54) Portable container assembly

(76) Inventor: Nikolai Duvigneau, Zichron Yaacov (IL)

Correspondence Address: Gary M. Nath;NATH & ASSOCIATES PLLC, 112 South West Street, Alexandria, VA, 22314, US

(21) Appl. No.: 11/646,590

(22) Filed: Dec. 28, 2006

Related U.S. Application Data
(63) Continuation-in-part of application No. 11/430,006, filed on May 9, 2006.
(60) Provisional application No. 60/681,159, filed on May 16, 2005.

(51) Int. Cl. B62B 1/00

(52) U.S. Cl. 280/47.26

(57) ABSTRACT

A tool caddy comprising a rigid base cabinet, and at least one detachable container made from a pliable material and designed as an independent carrying bag.

This application is a Continuation in Part, and claims the benefit of U.S. application Ser. No. 11/430,006, filed on May 5, 2006, which claims benefit of U.S. provisional application No. 61/681,159, filed on May 16, 2005.

### FIELD OF THE INVENTION

This invention relates generally to containers adapted to store any items a person may require such as hobby gear (fishing equipment, remote controlled items, etc), tools, nuts and bolts, and whatever other articles a worker requires to perform various tasks at a workplace, and more particularly to a portable container assembly which can be transported to a workplace.

Whilst hereinafter in the specification and claims the assembly is referred to as a tool assembly, it should be understood in its broad meaning, namely suited for any type of equipment and gear.

### BACKGROUND OF THE INVENTION

When a mechanic works in a garage to repair automobiles, the tools, the gauges, the bolts and all other articles he may require for this purpose are then available to the mechanic in a workshop.

But when a worker is required to go to a work place which is not a workshop in that it lacks the tools and other articles needed by the worker to perform various tasks, then the worker must bring along to the work place whatever tools and articles he needs to do the job he is expected to carry out, thereby converting the unequipped work place into a workshop.

In those cases where the tools and other articles the worker requires for the job at the work place can be stored in a tool box, then the worker can hand carry the tool box to the work place and then, in effect, transform it to a workshop. But more often than not, what the worker needs to bring to the work place cannot be fully accommodated even in an exceptionally large-capacity tool box.

To make it possible to transport to a workplace a container capable of storing not only tools but whatever other articles are necessary to carry out the job to be performed at the work place, it is known to provide for this purpose a portable container. Examples of portable container assemblies are disclosed, for example, in U.S. Pat. No. 6,374,847 to Tirami et al, directed to a rolling containers assembly including (a) a base cabinet including wheels and (b) at least one additional cabinet being removably connectable on top of the base cabinet, the additional cabinet having a pulling handle for locomotins the rolling containers assembly.

U.S. Pat. No. 6,374,847 also to Tirami et al is directed to a rolling containers assembly including (a) a base cabinet including wheels and a pulling handle for locomoting the rolling containers assembly; and (b) at least one additional cabinet being removably connectable on top of the base cabinet.

U.S. Pat. No. 6,371,320 assigned to the same Applicant as the present invention is concerned with a portable workshop container assembly adapted to store tools and other articles a worker requires to perform various tasks at a workplace. The assembly includes three major components in stacked relation. The lower component is a wheeled bucket, the middle component is a tray nested in the bucket and provided with a rim, and the third component is a tool box that rests on the rim. Also provided is a latching mechanism having a latch which is pivoted by a toggle member to the upper end of the bucket and cooperates with a first catch element mounted at the bottom of the tool box and a second catch element mounted on the rim of the tray. When the tool box rests on the rim, the first and second catch elements are then adjacent each other. In one mode of operation, the latch simultaneously engages the first and second latch elements to interlock all three components to form a unitary assembly that can be wheeled to the work place.

Still an arrangement is disclosed in U.S. Pat. No. 5,240,264 is concerned with a wheeled container having multiple closed compartments which can be removed and handled individually. The container can be easily assembled and disassembled for storage and transport, and where the wheels which fold away when not in use.

At times there may be a need to carry items to a location to where the portable container can not be locomoted, e.g. owing to sandy or rough terrain. For example, when going fishing, the fisherman may locomote the wheeled assembly as near as the shore but will not take it in the water with him. Another example may be a repairman required to carry some tools and equipment to install a chandelier. He may bring the assembly as near as below the working site but will then have to climb up and down a ladder each time he wishes to reach for a tool or piece of equipment.

It is an object of the present invention to provide a container assembly, wherein at least one container is a detachably articulated for carrying away items in an easy to carry container made of pliable material.

### SUMMARY OF THE INVENTION

According to the present invention there is provided a tool caddy comprising a rigid base cabinet, and at least one detachable container made from a pliable material and designed as an independent carrying bag.

The term carrying bag as used herein denotes a bag substantially made of pliable material e.g. fabric, Gore-Tex™, plastic, Cordura®, etc. and fitted with carrying means, e.g., one or more of handles, shoulder straps and back straps, or a combination thereof.

The base cabinet may comprise a handle articulated thereto, the handle being adapted to move between an upright position and a lowered position. The base cabinet may comprise an upper edge defining an open top, the handle being pivotally articulated thereto between the upright position and the lowered position, wherein in the lowered position the handle is filly received within said open top.

The detachable container may be substantially made of pliable material and fitted with carrying arrangements being one or more of handles, shoulder straps and back straps. In addition, a base portion of the detachable container is padded on an exterior thereof for use as a back pack.

The detachable container may be adapted for use as a wheeled tote. As such, it may comprise a telescoping handle.

The detachable container (i.e., the carrying bag), according to one embodiment, is fitted with a rigid base portion made of a substantially rigid material and fitted for articulation to the based cabinet. The rigid base comprises catch arrangements for engagement with a latch of the base cabinet. The rigid base may be in the form of a frame supporting a sheet material serving as a base, or it may be a solid member with a solid base.

According to one embodiment of the invention, the detachable container is detachably attachable for mounting over a top of the base cabinet such that there extends a gap between said top surface and between the base portion of the detachable container, the gap serving as a storage compartment for carrying straps of the bag, while not in use.

The base cabinet may be designed in different modifications. For example, it may comprise one or more bins tiltable between an inclined, open position and an upright (erect) closed position. There may also be provided one or more drawers or trays slidingly received within the base cabinet.

One or more trays may be incorporated in the base cabinet for storage of small items, said trays being designed for removal from the base cabinet. A top tray may constitute a closure for the base cabinet when the detachable container is removed therefrom, said tray fitted for fastening means for securing to the base cabinet. Optionally, a carrying handle is fitted to the tray for carrying of the assembled tray and base cabinet.

According to one particular design, the base cabinet is in the form of a basket or bucket with an open top closable by a tray, and where the detachable container is fitted for detachably connecting to the tray or directly to the upper edge of the bucket. The tray may be attachable to the top edge of the base cabinet, and/or it may be fitted with a carrying handle.

An uppermost member of the base cabinet may be formed with a top wall surface for supporting the detachable container. The top wall of the uppermost member may further be formed with a shouldering rim for at least partially supporting and snuggling respective portions of a base portion of the detachable container.

The pliable material of the detachable container may be adapted to collapse to a relatively flat position.

The base cabinet may be part of a modular system where modular elements adapted for interconnecting are provided such that a user may assemble an array of compartments and cabinets to create a base cabinet, however with the detachable container constituting one of said modular elements, typically adapted for articulating as an uppermost component.

The detachable container may be replaceable by a suitable rigid compartment formed with a base mimicking that of the base portion of the detachable container.

According to an embodiment of the present invention, a top member of the base cabinet is formed with a top wall surface for supporting the detachable container and optionally there is a peripheral shoulder around at least a portion of said top wall surface, snuggling respective portions of a base portion of the detachable container.

The base portion of the detachable container, according to one embodiment, is sufficiently deep to accommodate the pliable portion of the detachable container, while not in use. According to a modification of this embodiment, the detachable container may be articulated over a top surface of the base cabinet in a bottom-up position, i.e., such that the pliable bag is collapsed and fully received within a basin of the base portion, and the base portion is attached in this fashion to the base cabinet.

The handle of the assembly is fitted to the base cabinet and is typically a collapsible or telescopic handle deformable between a collapsed or retracted position and an operative extended or extracted position.

Attachment of the detachable container to the base cabinet may be facilitated by a variety of arrangements of an attaching mechanism, e.g., sliding catch, pivotable latch, snapping closure, toggle latch, etc. The attaching mechanism may be a latching mechanism comprising a latch fitted on either the detachable container or the base cabinet with a corresponding latching lock fitted on the other of the detachable container and the base cabinet. It is appreciated that instead of the detachable container there may be attached over the base cabinet a tool case made of rigid material, where articulation thereto may be facilitated by the same attaching mechanism.

The base cabinet and the detachable container are each fitted with a carrying arrangement, e.g. a handle and/or shoulder strap, etc.

### BRIEF DESCRIPTION OF THE DRAWINGS

In order to understand the invention and to see how it may be carried out in practice, some embodiments will now be described, by way of non-limiting examples only, with reference to the accompanying drawings, in which:

FIG. 1A is an isometric view of a wheeled cabinet assembly in accordance with a first embodiment of the present invention;

FIG. 2A is an isometric view of the carrying bag of the cabinet assembly seen in FIG. 1, detached therefrom;

FIG. 2B is a rear isometric view of the base cabinet of the cabinet assembly seen in FIG. 1, with the carrying bag removed therefrom;

FIG. 3 is an exploded isometric view of a portion of the wheeled cabinet assembly of FIG. 1, illustrating the latching mechanism, wherein the base portion of the carrying bag is illustrated in solid and the body portion thereof is illustrated in dashed lines;

FIG. 4A is a rear isometric view of a cabinet assembly in accordance with a second embodiment of the present invention, the carrying bag shown partially in dashed lines;

FIG. 4B is a front isometric view of the cabinet assembly seen in FIG. 4A, with the carrying bag disengaged from the base cabinet;

FIG. 5 is a front exploded isometric view of the base cabinet of the cabinet assembly seen in FIGS. 4A and 4B;

FIG. 6 is an isometric view of a latching portion of the cabinet assembly illustrated in FIGS. 4A and 4B;

FIG. 7 is an isometric view of a tool caddy in accordance with an embodiment of the present invention;

FIGS. 8A and 8B are isometric views of a base cabinet of the tool caddy illustrated in FIG. 7, with a handle thereof at an upright and a lowered position, respectively;

FIG. 9A is an isometric view of a carrying bag of the tool caddy illustrated in FIG. 7;

FIG. 9B is an underside view of the carrying bag illustrated in FIG. 9A;

FIGS. 9C and 9D illustrate different embodiment of the carrying bag illustrated in FIGS. 9A and 9B; and

FIG. 10 illustrates how the tool caddy may be carried when the carrying bag illustrated in FIGS. 9A and 9B is detached from the base cabinet illustrated in FIGS. 8A and 8B.

### DETAILED DESCRIPTION OF EXEMPLARY EMBODIMENTS

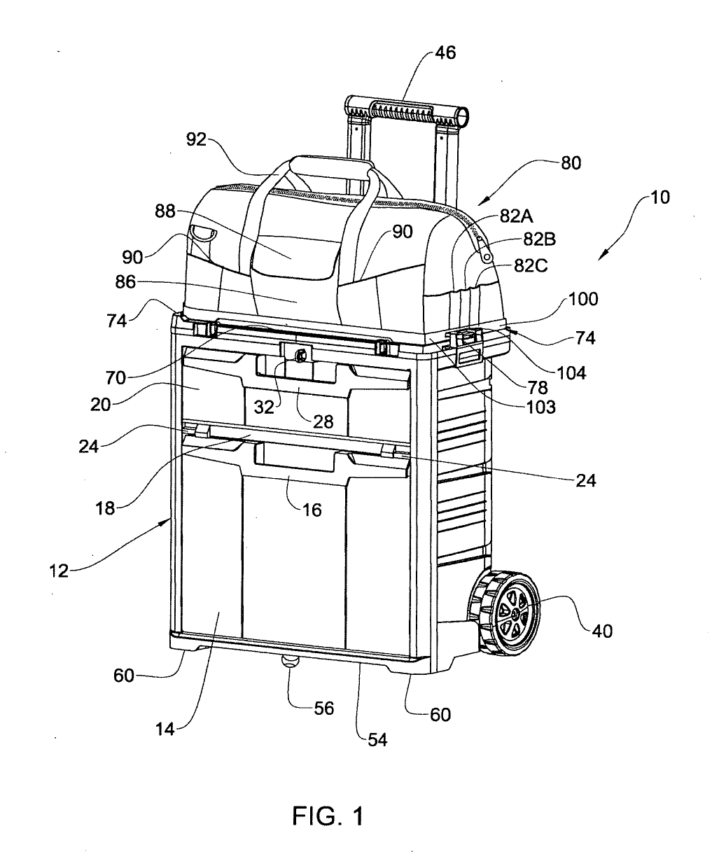

Attention is first directed to FIG. 1 of the drawings illustrating a cabinet assembly in accordance with the first embodiment of the present invention generally designated 10, comprising a rigid base cabinet 12 fitted with a tilting bin 14 accessible by pulling at handle 16 in a pivoting manner. Above the bin 14 there is a fixed shelf 18 giving rise to a storage compartment closable by a door 20 pivotally secured at 24 to the base cabinet. Door 20 is fitted with a handle 28 and an opening through which projects a locking eye 32, for a lock to be mounted, to thereby lock the compartment 18 and prevent unauthorized opening thereof.

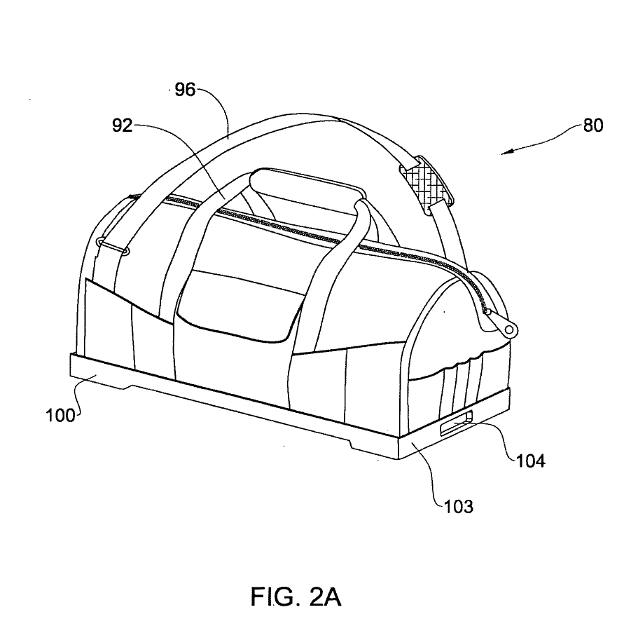

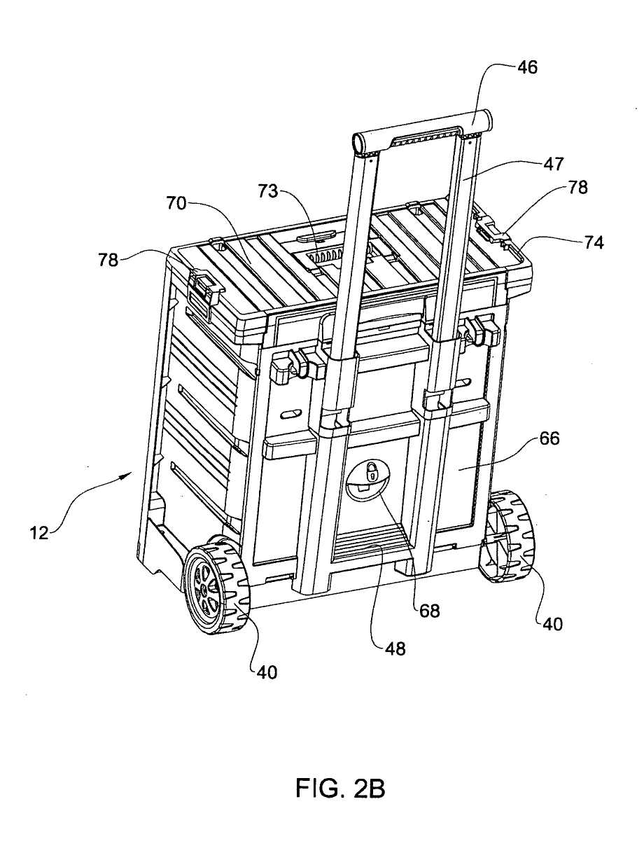

As can further be seen in FIGS. 1 and 2B, the base cabinet 12 comprises a pair of wheels 40 (only one seen in FIG. 1) fitted at a rear lower end of the base cabinet so as to facilitate locomoting the cabinet assembly by pulling at handle 46. As can be seen also in FIG. 2B, the handle 46 is in the form of a telescopic handle with two retractable bars 47 displaceable between a retracted position (not shown) and an operative position in which the handle is extracted as in the figures, to facilitate displacement of the cabinet assembly 10 by pulling. For that purpose, the cabinet assembly is typically tilted over the rear wheels 40 and there is formed, at lower portion of the rear face of the cabinet base a footstep portion 48 to assist in tilting of the cabinet.

In the embodiment of FIG. 1 the a base 54 of the base cabinet 12 is fitted with a front swiveled wheel 56 both for supporting the cabinet assembly 10 at its essentially erect position and also to facilitate pushing it as to roll it at this erect position (typically over a short distance i.e. repositioning). The swiveled wheel 56 may be integrated with the base 54 of the base cabinet or it may be detachably articulated thereto. Alternatively, or in addition, the bottom wall of the base cabinet is formed with rests 60 for supporting the cabinet assembly 10 while at the erect position, in rest.

Also noticeable in FIG. 2B, the base cabinet 12 is fitted at its rear wall 66 with a locking eye 68 engageable with a rear wall of the tiltable cabinet 14 to thereby lock the cabinet 14 and prevent unauthorized opening thereof.

Still noticed in FIG. 2B, a top wall 70 of the base cabinet 12 is fitted with a handle 74 to thereby facilitate lifting the base cabinet and carrying it over obstacles, inserting it into a car, etc. handle 74 substantially does not project from the surface of the top wall 70.

It is further noticed that the top wall 70 is formed with a seating in the form of a partial peripheral shouldering rim 74 and with two pivot latches 78, one at each side of the base cabinet 12, the purpose of which will become apparent hereinafter.

As seen in FIG. 1, and in detail in FIG. 2A, a carrying bag 80 is mounted on the top wall 70 of the base cabinet 12, said carrying bag 80 being made of a resilient material such as reinforced cloth, Gortex®, nylon, etc. The carrying bag 80 is typically formed with a plurality of pockets 82A, 82B, 82C, etc., each sized to accommodate different pieces of equipment and gear at user's choice. The bag 80 further comprises an external pocket 86 closed by a flap cover 88 and several pockets 90 adapted to receive a carrying handle 92 or a shoulder strap 96 (FIG. 2A), respectively, when not in used.

The arrangement is such that the carrying bag 80 is made of a pliable material and is formed with a rigid base portion 100, said base portion retaining a fixed shape and comprises depressions 104 at opposed sides thereof fitted for engagement by latches 78 of the base cabinet 12.

Base portion 100 of carrying bag 80 is sized and shaped for receiving over the top wall 70 of base cabinet 12 such that the side walls 103 are at least partially supported by peripheral shouldering rim 74 of the base cabinet.

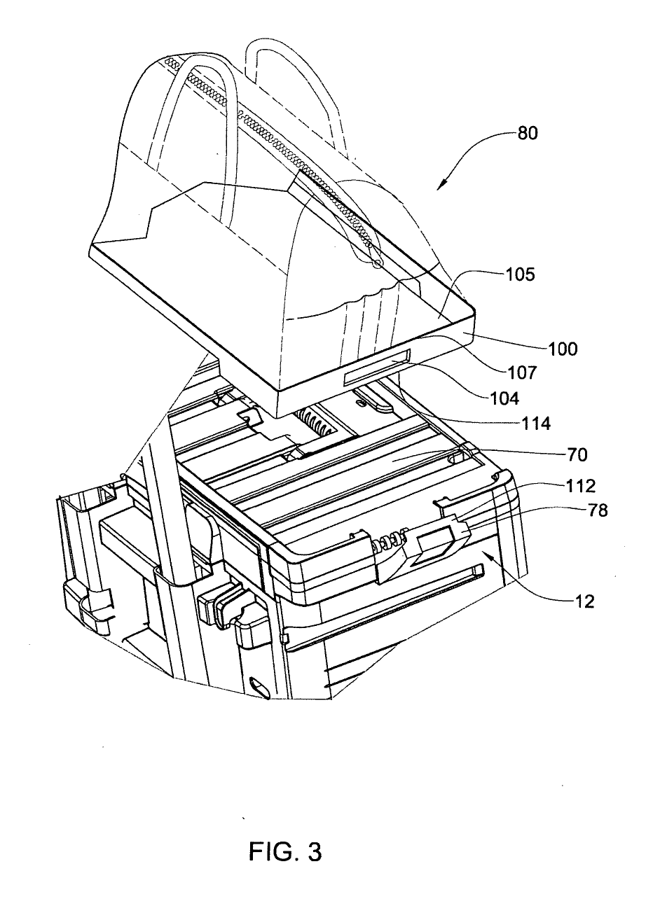

As can be seen in FIG. 3, the base portion 100 of the carrying bag 80 is in the form of a solid basin-like structure into which the fabric structure of the carrying bag is fixedly fitted (see FIG. 2A). In accordance with the embodiment of FIG. 3, the base member 100 is designed that such when it is assembled over the base cabinet 12, there is a gap formed between a bottom surface of the bottom portion 100 and the top wall surface 70 of the base cabinet 12. This gap can be used for example to store shoulder strap 96 of the carrying bag, a pair of back straps (not shown), etc.

In accordance with a modification of the invention, a bottom surface of the bottom portion 100 may be padded with a soft material to facilitate carrying of the soft bag 80 as a back pack.

Whilst it appears from FIG. 3 that the base portion 100 of the carrying bag is a solid basin-like member, it should be realized that the base member mat also be in the form of a rigid frame with pliable material attached thereto for constituting the base of the carrying bag.

The basin-like base portion 100 of the carrying bag 80 is illustrated in the embodiment of FIG. 3 such that it is sufficiently deep to receive the pliable portions of the carrying bag 80 collapsed into the basin 105 such that it does not extend over the edges 107, in a storage position.

In accordance with a modification (not shown) the carrying bag is designed such that its base portion may be articulated to the base cabinet 12 in an inverted position (i.e. ‘bottoms up’) such that the pliable portions of the carrying bag 80 are fully received within the basin 105 and the gap extending over the top wall 70 of the base cabinet 12.

Also seen in more detail in FIG. 3 is the pivoting latch 78 which in this figure is illustrated in its open position with its claw 112 adapted for arresting wall portion 114 of base portion 100.

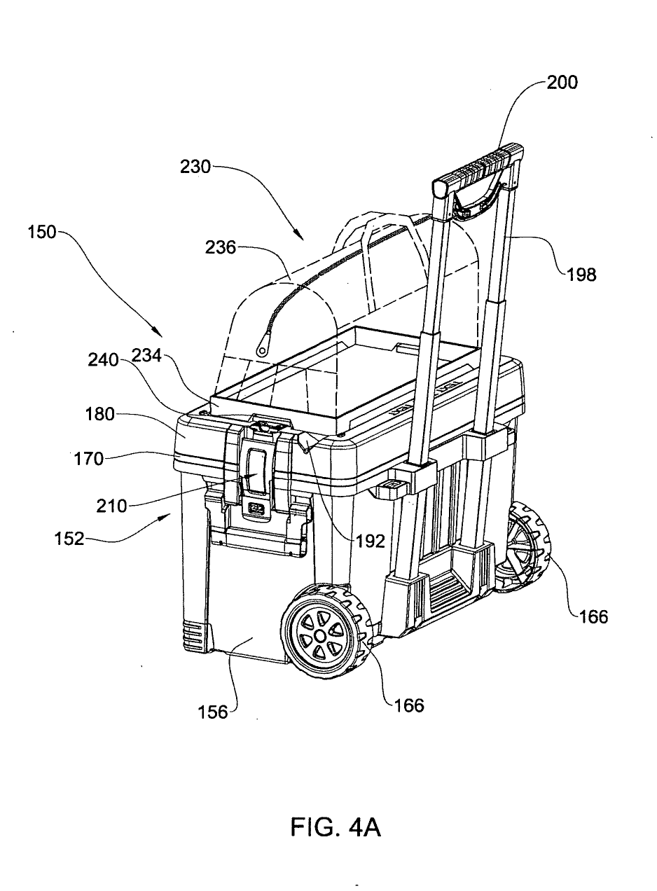

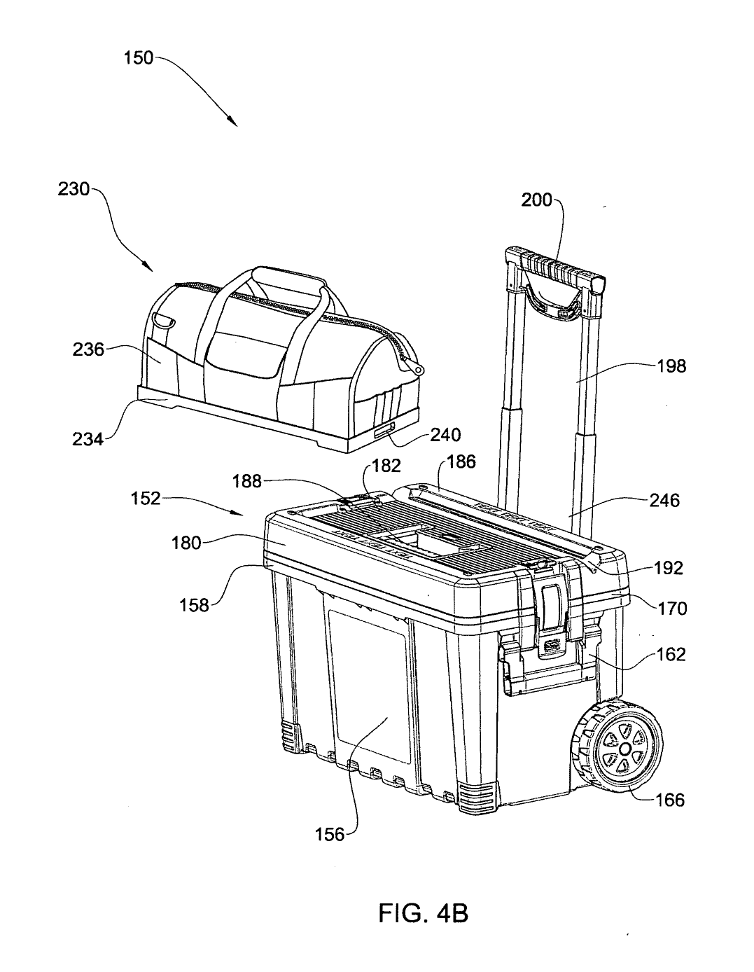

Turning now to FIGS. 4 to 6 of the drawings there is illustrated a different embodiment of the present invention generally designated 150. In this embodiment, the rigid base cabinet 152 comprises a bucket 156 having an open top defined by a peripheral top edge 158 and fitted at two opposed side walls thereof with carrying handles 162. A pair of rolling wheels 166 are pivotally secured at a bottom rear edge of the cabinet assembly 152.

The cabinet assembly 152 further comprises a tray member 170 formed with a peripheral rim 174 adapted for resting over top edge 158 of bucket 156 and further fitted with a carrying handle 176 to assist in removal thereof. Tray 170 is compartmented for storage of small articles such as screwdrivers, bolts, drilling bits, etc.

Mounted over the tray 170 there is a cover 180 fitted for assembly over the peripheral shoulder 174 of tray 170. Cover 180 has a top wall 182 depressed below its upper surface 186 and comprising a central handle 188 to facilitate transporting the base cabinet, at its closed position, e.g. over obstacles, etc., by lifting thereof.

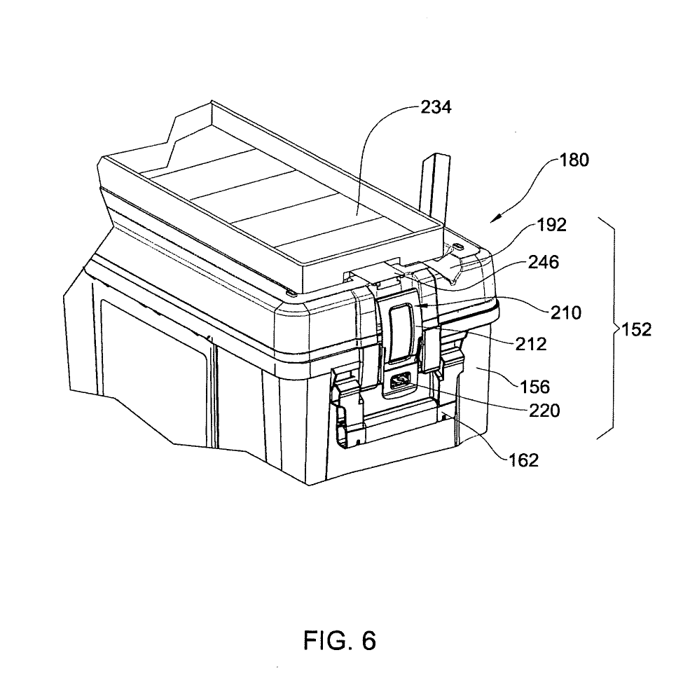

As can further be seen, best in FIGS. 4d and 6, the top cover 180 is formed at its top wall with a V-like longitudinal groove 192 serving to support a longitudinal work piece, e.g. while cutting, drilling, etc.

The cabinet assembly 152 further comprises a locomoting handle 198 which, similar to the previous embodiment, is a telescopic retractable handle, shown in FIGS. 4A to 6 in its fully extracted operative position. However, in its retracted position, the handlebar 200 does not project over the top edge 192 of cover 180.

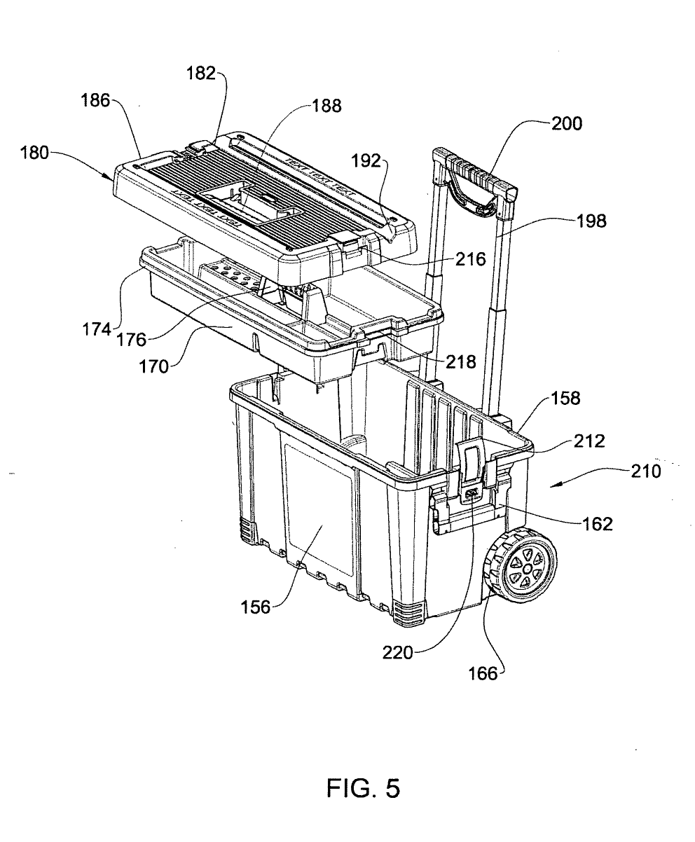

Further noticeable is a latching mechanism generally designated 210 (see also FIG. 6) comprising a latch 212 pivotally articulated to the bucket 156 adapted to simultaneously engage with a latch arresting portion 216 (FIG. 5) of the cover 180 and a recess portion 218 of the tray 170, so as to interlock the bucket 156, the tray 170 and the cover 180 to thereby form a unitary base cabinet 152. The latch 212 comprises an opening through which extends a locking eye 220 for retaining the base cabinet 152 in a closed position to prevent unauthorized opening thereof.

As mentioned above, the top wall 182 of cover 180 is depressed and extends below a top surface 186 thereof thus forming a seating surface to accommodate a detachable container (carrying bag 230), shown in the exploded view of FIG. 4B and illustrated in FIG. 4A such that its base portion 234 is illustrated in solid lines and the pliable body 236 is illustrated in this figure by dashed lines.

Similar to the previous embodiments, the carrying bag 230 has a rigid base portion 234 fitted for snugly receiving over the surface 182 of top cover 180, said bottom portion 234 comprises at its side edges two depressions 240 fitted for arresting by a sliding latch 246 fitted on cover 180 for detachably articulating the carrying bag 230 over the base cabinet 152. Disengagement of the carrying bag 230 from the base cabinet 152 is facilitated by slidingly displacing the latch 246 away from the base member 234, so as to disengage from the recesses 240.

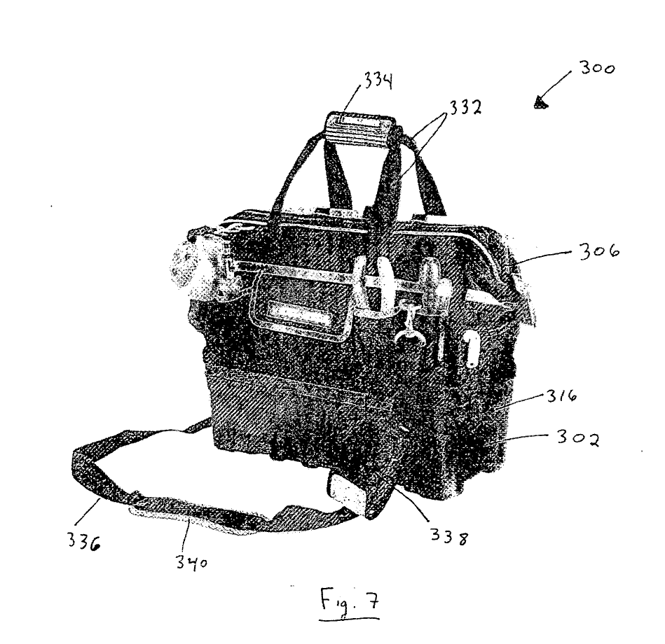

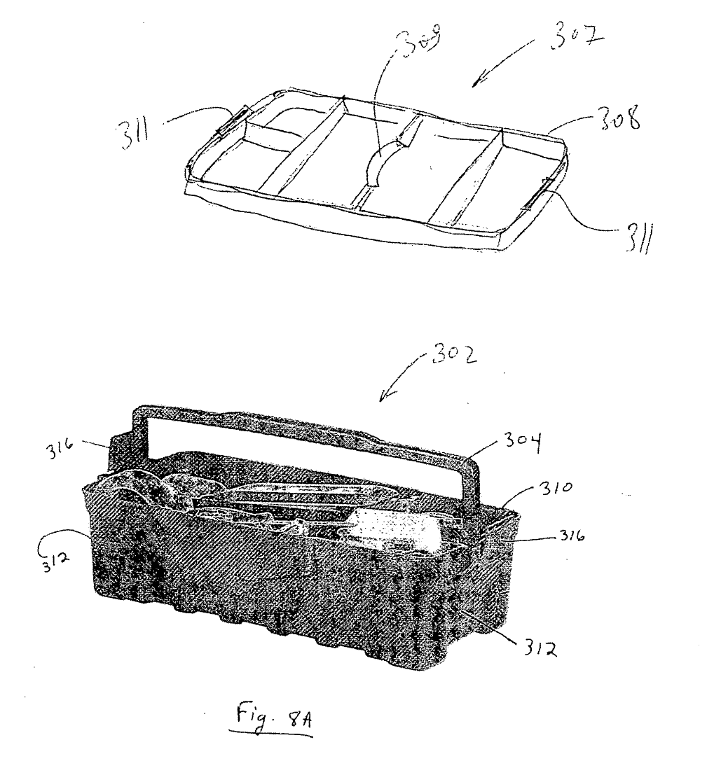

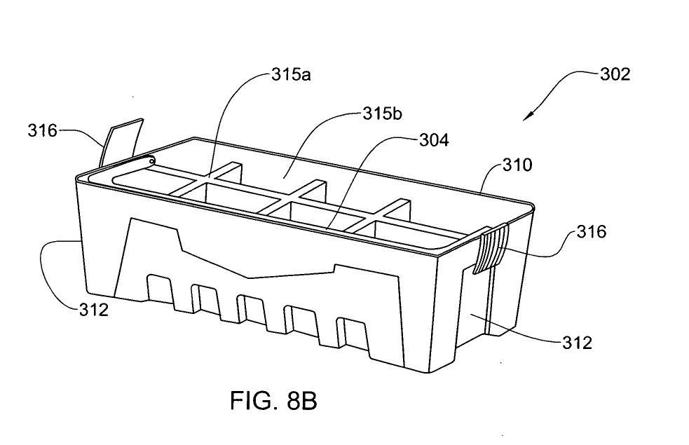

Turning now to FIGS. 7 through 10 of the drawings, according to a further embodiment of the present invention, there is provided a tool caddy, generally indicated at 300. In this embodiment, the base cabinet 302 is free of wheels and a telescoping/retractable handle, and instead comprises a rigid handle 304 pivotally attached thereto between an upright position (as seen in FIG. 8A) and a lowered position (as seen in FIG. 8B). A carrying bag 306, attachable to said base cabinet 302, is provided.

The base cabinet 302 has an open top defined by a peripheral top edge 310. It is formed with one compartment, and optionally there is provided a compartmented tray member 307 (FIG. 8A) formed with a peripheral rim 308 adapted for resting on the top edge of the base cabinet 302, similar to the embodiment described with reference to FIGS. 4 through 6. Furthermore, the tray 307 may be formed having compartments adapted to hold small parts such as nails, screws, etc., or larger items, such as hand tools, rulers, etc., or a combination of such compartments.

The handle 304 is pivotally articulated to the base cabinet 302 such that it spans to top edge between short sides 312 thereof, and is formed such that when it is in its lowered position, it is fully received within the open top as defined by the top edge 310.

However, according to an embodiment, the tray 307 is fitted with a carrying handle 309, and furthermore there are provided latching shoulders 311 for detachably attaching the tray 307 to the base cabinet 302 by latches 316 so that carrying of the assembled base cabinet is facilitated by the tray's handle 309. Additionally or instead a shoulder strap may be provided (not shown) securable to suitable hooks. The carrying handle 309 typically does not project from a top edge of the tray and if it does it is in conjunction with a suitable depression (not seen) formed at the base of the carrying bag 306. it is also noted that the top edge 308 of the tray 307 is adapted for articulation with a bottom of the base 314 of the carrying bag 306, for which purpose the top edge of the tray may resemble the top edge 310 of the base cabinet 302.

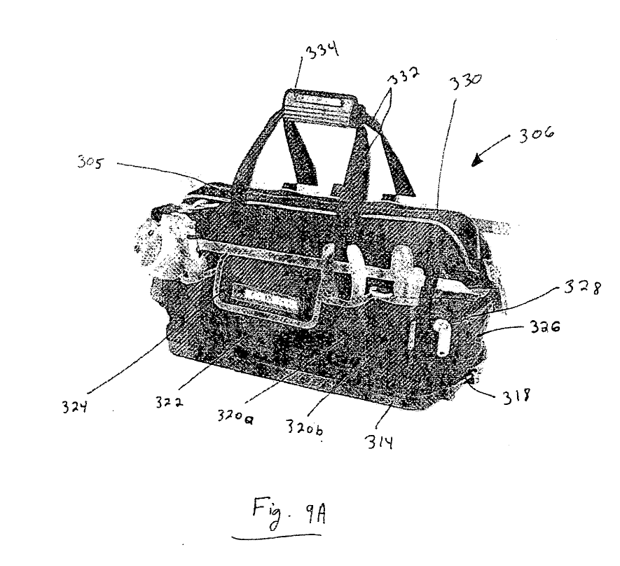

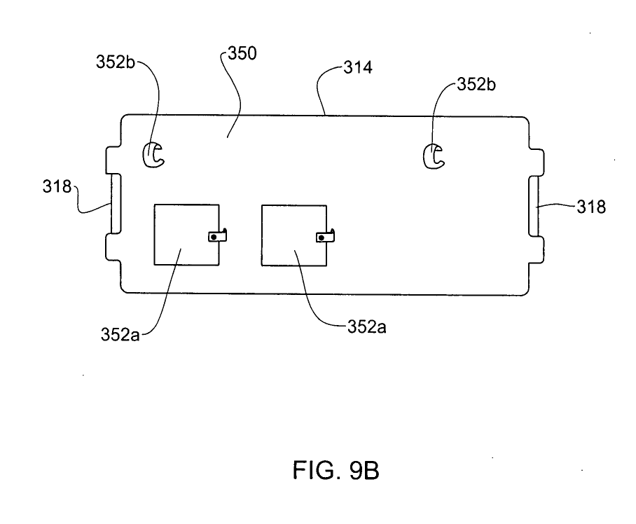

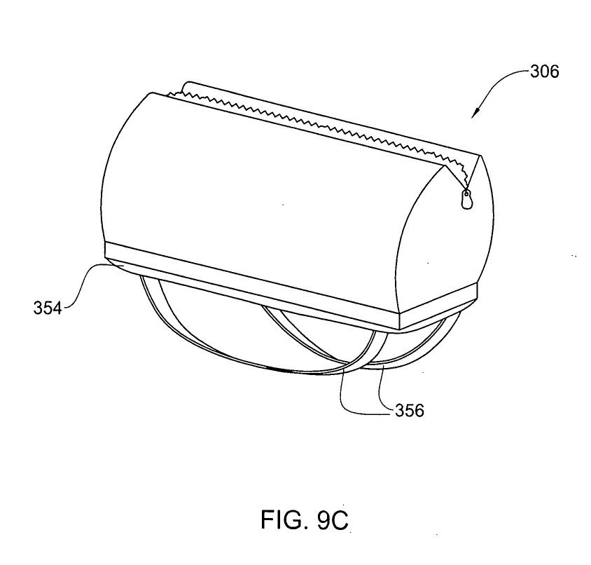

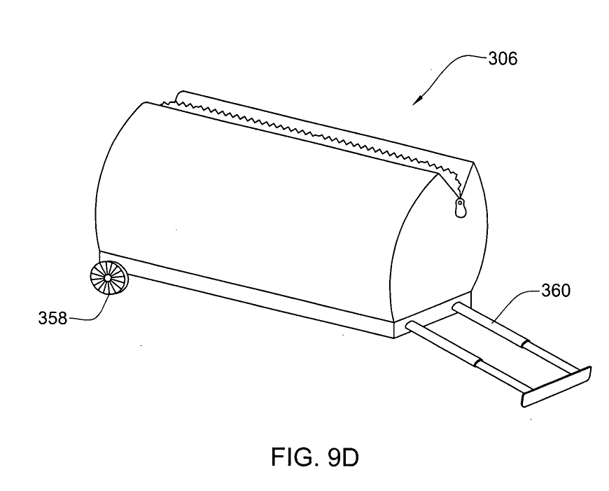

The base cabinet 302 comprises a latching mechanism consisting of a latch 316 pivotally articulated to the base cabinet and adapted to simultaneously engage with a latch arresting portion 318 (FIGS. 9A and 9B) formed on a rigid base 314 of the carrying bag 306, so as to interlock the base cabinet, when the handle 304 thereof is in its lowered position, and the carrying bag to thereby form the unitary tool caddy 300. The latch 316 may comprise an opening through which extends a locking eye for retaining the caddy 300 in a closed position to prevent unauthorized opening thereof (not seen).

As seen in FIG. 8B, the base cabinet 302 may further comprise partitions 315a which subdivide the base cabinet into compartments 315b, useful for organizing the contents thereof. The partitions 315a may be formed integrally with the base cabinet 302, or removable therefrom. In the latter case, the partitions 315a may be formed as one piece, or as several panels which are independently removable, such that a user may customize the arrangement and sizes of the compartments 315b.

Turning now to FIG. 9A, the carrying bag 306 is similar to the carrying bag 80 described above. Specifically, as stated above, it comprises a rigid base 314 in the form of a solid basin-like structure, and a fabric portion 305 made of a resilient or flexible material, such as reinforced cloth, Gore-Tex®, nylon, Cordura®, etc. The fabric portion 305 is typically formed with a plurality of external pockets 320a, 320b, etc. It may also comprise at least one closable pocket 322 closed by a flap cover 324, and/or one closeable pocket 326 closable by a zipper 328. The flap cover 324 may be secured in its closed position by a snap, a hook and pile arrangement such as Velcro®, etc. The carrying bag 306 is closeable by a zipper 330. The fabric portion 305 is sufficiently flexible to collapse to a relatively flat position when not in use.

As seen in FIG. 9B, an underside 350 of the base 314 may comprise pockets 352a, loops 352b, and other similar contrivances for holding papers, long tools such as 10 levels, etc. The pockets 252a may be snappably closeable.

In addition, the carrying bag 306 comprises flexible carrying handles 332, which may be made of the same material as the bag, and are securable to one another by a securing flap 334. The securing flap 334 is attached to one of the flexible handles, is wrapped around the two handles, and may be secured therearound by a securing arrangement such as snaps, Velcro®, etc. In this position, the securing flap 334 may constitute a hand grip. Therefore, it may have an outer layer made of a viscoelastic material, or other such material to ensure maximal comfort to a user while carrying via the handles 332. In addition, the flexible bag may comprise a flexible shoulder strap 336, which may comprise a case 338 attached thereto, such as for holding a cellular phone, etc. The shoulder strap 338 may additionally comprise a shoulder pad 340 to provide comfort to a user while carrying the caddy 300 or carrying bag 306 thereby.

According to a modification, as illustrated in FIG. 9C, the base 314 may be padded with a soft material 354, facilitating its use as a back pack, or any other type of bag. In addition, the handles 332 and shoulder strap 336 may be replaced with straps or handles which are appropriate for the intended use of the bag, such as shoulder straps 356 attached to the bottom of the base 314. Alternatively, as illustrated in FIG. 9D, wheels 358 may be provided at one end of the carrying bag 306, and a telescoping handle 360 (shown in an extended position) at the other, to facilitate its use as a wheeled tote.

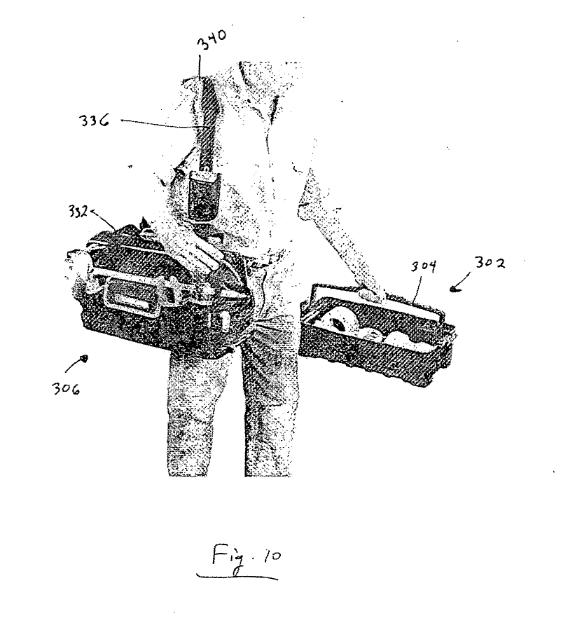

When the base cabinet 302 is attached to the carrying bag 306 as described above, the flexible handles 332 or the shoulder strap 336 may be used to carry the caddy 300. When the base cabinet 302 is detached from the carrying bag 306, the carrying bag may be carried by the flexible handles 332 or the shoulder strap 336, and the rigid handle 304, in its upright position, is used to carry the base cabinet, as illustrated in FIG. 10.

Whilst some embodiments have been described and illustrated with reference to some drawings, the artisan will appreciate that many variations are possible which do not depart from the general scope of the invention, mutatis, mutandis.

For example, the base cabinet may be designed in different modules and comprise any combination of drawers, bins, shelves and removable compartments (rigid or pliable). Furthermore, articulation of the pliable compartment, namely the carrying bag, may be facilitated by other arrangements then those disclosed.

1. A tool caddy comprising a rigid base cabinet, and at least one detachable container made from a pliable material and designed as an independent carrying bag.

2. A tool caddy according to claim 1, wherein the base cabinet comprises a handle articulated thereto, said handle adapted to move between an upright position and a lowered position.

3. A tool caddy according to claim 2, the base cabinet comprises an upper edge defining an open top and said handle is pivotally articulated thereto between the upright position and the lowered position, wherein in the lowered position the handle is fully received within said open top.

4. A tool caddy according to claim 1, wherein the detachable container is substantially made of pliable material and is fitted with carrying arrangements being one or more of handles, shoulder straps and back straps.

5. A tool caddy according to claim 4, wherein a base portion of the detachable container is padded on an exterior thereof for use as a back pack.

6. A tool caddy according to claim 1, wherein the detachable container is adapted for use as a wheeled tote.

7. A tool caddy according to claim 6, wherein the detachable container comprises a telescoping handle.

8. A tool caddy according to claim 1, wherein a base portion of the detachable container is made of a substantially rigid material and is fitted for detachably articulation to the base cabinet.

9. A tool caddy according to claim 8, wherein the base portion of the detachable container is a solid member or in the form of a frame supporting a sheet material serving as a base.

10. A tool caddy according to claim 1, wherein the detachable container is detachably mounted over a top surface of the base cabinet such that there extends a gap between said top surface and between a base portion of the detachable container, said gap serving as a storage compartment for carrying straps of the detachable container, while not in use.

11. A tool caddy according to claim 1, wherein the base cabinet is in the form of a bucket with an open top edge closable by a tray, and where the detachable container is fitted for detachably interconnecting to the tray and bucket or directly to the top edge of the bucket.

12. A tool caddy according to claim 11, wherein the tray is attachable to the top edge of the base cabinet.

13. A tool caddy according to claim 12, wherein the tray is fitted with a carrying handle.

14. A tool caddy according to claim 1, wherein an uppermost member of the base cabinet is formed with a top wall surface for supporting the detachable container.

15. A tool caddy according to claim 14, wherein the top wall of the uppermost member is formed with a shouldering rim for at least partially supporting and snuggling respective portions of a base portion of the detachable container.

16. A tool caddy according to claim 1, wherein the pliable material of the detachable container is adapted to collapse to a relatively flat position.

17. A tool caddy according to claim 5, wherein the base portion of the detachable container is sufficiently deep to accommodate the pliable portion of the detachable container, while not in use.

18. A tool caddy according to claim 15, wherein the detachable container may be articulated over a top surface of the base cabinet in a bottoms-up position, such that the detachable container is collapsed and fully received within a basin of the base portion, and the base portion is attached in this fashion to the base cabinet.

19. A tool caddy according to claim 1, wherein the detachable container is articulated to the base cabinet by one of a sliding catch, a pivotable latch, a toggle latch, and a snapping closure.

20. A tool caddy according to claim 1, wherein the detachable container is replaceable by a suitable rigid compartment formed with a base mimicking that of the base portion of the detachable container.

21. A tool caddy according to claim 1, wherein the base cabinet comprises one or more bins tiltable between an inclined, open position and an upright closed position.

22. A tool caddy according to claim 1, wherein the base cabinet comprises one or more drawers or trays slidingly received within the base cabinet.

23. A tool caddy according to claim 1, wherein the base constitutes part of a modular system comprising modular compartment elements adapted for interconnecting such that a user may assemble an array of compartments and cabinets to create a base cabinet, however with the detachable container constituting one of said modular elements, adapted for articulating as an uppermost component.
